(19) United States
(12) Patent Application Publication
(10) Pub. No.: US 2012/0171651 A1
(43) Pub. Date: Jul. 5, 2012

(54) THERAPEUTIC SENSORY DEVICE FOR TACTILE REHABILITATION

(76) Inventor: Todd Renzelman, Lakewood, OH (US)

(21) Appl. No.: 12/983,356

(22) Filed: Jan. 3, 2011

(51) Int. Cl. G09B 23/28

(52) U.S. Cl. 434/262

(57) ABSTRACT

A therapeutic sensory device and method of using the device for the aid in the rehabilitation of an individual's sense of touch including a first planar sheet having a plurality of spaced sensory pads, disposed thereon; a plurality of elements, each having a sensory pad corresponding to one of the spaced sensory pads, each of said plurality of elements being adapted to be placed on the corresponding sensory pad disposed on the first planar sheet; and a structure to removably secure the plurality of elements atop the corresponding sensory pad disposed on the first planar sheet. The plurality of elements are selectively placed atop the corresponding sensory pad disposed on the first planar sheet. Then, one or more of the plurality of elements are removably secured atop the corresponding sensory pad disposed on the first planar sheet.

### TECHNICAL FIELD OF THE INVENTION

The present invention relates generally to a therapeutic sensory device for use in the rehabilitation of an individual's sense of touch, and more particularly to a sheet with sensory pads and elements having corresponding pads that the individual patient must match with the sensory pads on the sheet based on the feel of the pads.

### BACKGROUND OF THE INVENTION

Occupational therapy is the therapeutic use of self-care, work, and recreational activities to increase independent function, enhance development, and prevent disability. The goals of occupational therapy include directing participation in selected tasks to restore, reinforce, and enhance physical performance; facilitating the learning of skills and functions essential for adaptation and productivity; and promoting and maintain health. Many devices have been developed for patients to aid in their rehabilitation.

One such role of the above mentioned therapy is the restoration and rehabilitation of the sense of touch. It is not uncommon for a patient to have a lost or diminished sense of touch. The loss of this sense can have a debilitating effect on the life of the patient. The present invention is a means of therapy which may be utilized to repair and otherwise assist in tactile recovery, through the use of sensory stimulation.

### SUMMARY OF THE INVENTION

According to the present invention, there is disclosed a therapeutic sensory device and method of using the device for the aid in the rehabilitation of an individual's sense of touch including a first planar sheet having a plurality of spaced sensory pads, disposed thereon; a plurality of elements, each having a sensory pad corresponding to one of the spaced sensory pads, each of said plurality of elements being adapted to be placed on the corresponding sensory pad disposed on the first planar sheet; and a structure to removably secure the plurality of elements atop the corresponding sensory pad disposed on the first planar sheet.

Further according to the present invention, there is disclosed a method for rehabilitating an individual's sense of touch. The method includes providing a first planar sheet having a plurality of spaced sensory pads disposed thereon and a plurality of elements, each having a sensory pad corresponding to one of the spaced sensory pad. The plurality of elements are selectively placed atop the corresponding sensory pad disposed on the first planar sheet. Then, one or more of the plurality of elements are removably secured atop the corresponding sensory pad disposed on the first planar sheet.

### BRIEF DESCRIPTION OF THE DRAWINGS

The structure, operation, and advantages of the present invention will become further apparent upon consideration of the following description taken in conjunction with the accompanying Figures (FIGs.). The Figures are intended to be illustrative, not limiting. Certain elements in some of the Figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

FIG. 1 is a three dimensional view of the therapeutic sensory device with the lower shelf portion in place, in accordance with the present invention.

FIG. 2 is a three dimensional view of the therapeutic sensory device with the lower shelf portion extended and the curtain portion illustrated, in accordance with the present invention.

FIG. 3 is a top view of the two sheets, one that includes the spaced sensory pads and one that has openings corresponding to the spaced sensory pads through which elements with corresponding sensory pads are disposed, in accordance with the present invention.

FIG. 4 is a partial, three dimensional view of a sheet with sensory pads and side supports to hold sensory pads elements in place, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

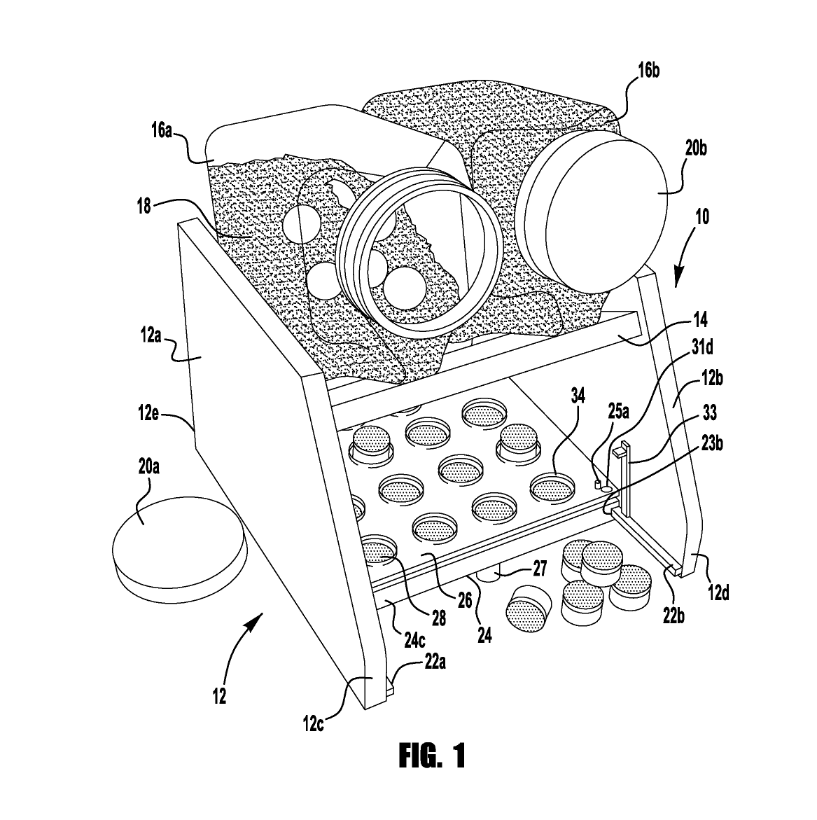

FIG. 1 illustrates the present invention, a therapeutic sensory device 10 designed to assist with the rehabilitation and/or rejuvenation of a patient's tactile senses. Therapeutic sensory device 10 includes a housing 12 that may be constructed out of any appropriate material, such as plastic, metal, or wood, but as presently illustrated, it is constructed from wood.

The housing 12 of the therapeutic sensory device 10 can be constructed of two spaced, parallel side walls, 12a and 12b, with an upper shelf 14 there between. Disposed upon upper shelf 14 are two containers, 16a and 16b. Each container contains a medium 18, such as sand, straw, powder, etc. While two containers are shown, it is within the terms of the invention to provide one or more containers. Each of the containers 16a and 16b can include corresponding lids or caps, 20a and 20b. As illustrated, the cap 20b is secured to the container 16b. While the containers 16a and 16b are illustrated as being disposed on the upper shelf 14, it is also within the terms of the invention to dispose the containers at a location spaced from the housing 12.

Walls 12a and 12b of the housing 12 are constructed with elongated ridges 22a and 22b, that are parallel to each other and extend from the front 12c, 12d to the rear 12e, 12f (not shown) of the housing, along the lower portion of the interior walls 12a and 12b, respectively.

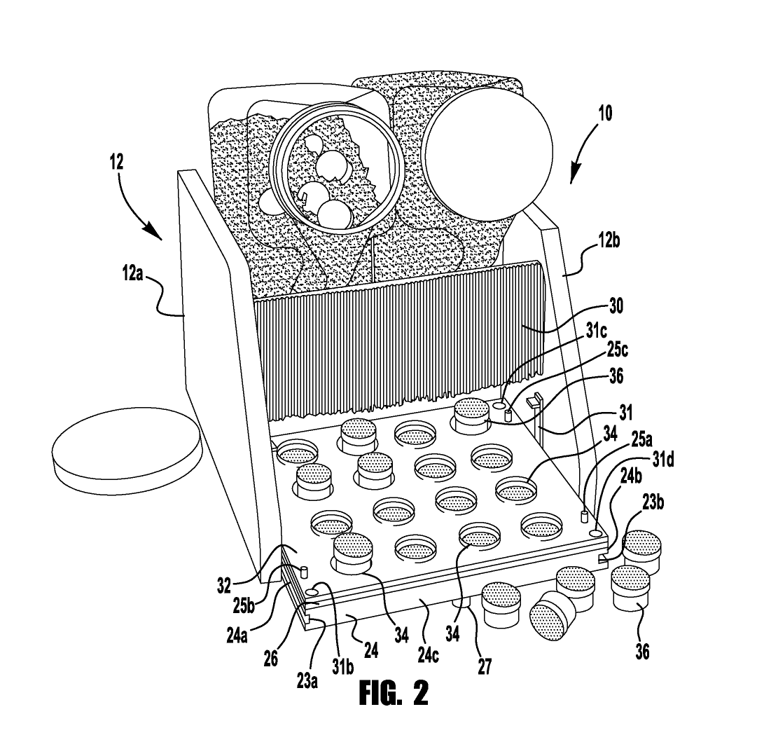

A lower shelf 24 is constructed with grooves 23a, 23b (see FIG. 2) along its side walls 24a, 24b, respectively, to receive ridges 22a and 22b, respectively. This arrangement allows lower shelf 24 to slide back and forth between the front and rear of the housing 12. There are blocks (not shown) added along the ridges 22a and 22b that prevent the lower shelf 24 from being pulled too far forward from the housing (unless the blocks are removed). In at least two corners of lower shelf 24 can be upstanding pins 25a and 25b, (see FIG. 2). Preferably, there are four upstanding pins 25a, 25b, 25c and 25d (not shown) as shown in FIG. 2. Under lower shelf 24 can be provided a small protective protrusion 27 to prevent the shelf from tilting when in the extended position. Further, there is a slide bar or metal clasp 33 which can be moved downward to engage the front edge 24c of lower shelf 24 and thereby keep the lower shelf 24 in its operative position, as shown in FIG. 1.

A first planar sheet 26, (see FIG. 3), preferably constructed of a semi-rigid material, such as plastic or sheet metal, has a plurality of spaced sensory pads 28 attached thereon. Each spaced sensory pad 28 can have a different texture, such as sandpaper, fur, cloth, glass, and plastic. While the pads 28 are circular, it is within the terms of the invention to form them of a different shape. It is within the terms of the invention that there be several different replaceable first planar sheets 26 with different levels of sensitivity of spaced sensory pads 28, including fine (difficult level), medium (moderately difficult level), and coarse (easy level).

There are four holes 29a, 29b, 29c, and 29d through the first planar sheet 26, one in each corner, through which pins 25a, 25b, 25c, 25d (not shown) can be disposed to secure the first planar sheet 26 to the top surface of the lower shelf 24. See FIG. 2. It is also within the terms of the present invention for an upstanding post to be disposed in two or more corners of the first planar sheet 26.

FIG. 2 illustrates therapeutic sensory device 10 with lower shelf 24 extended outward from the housing 12. Suspended downward along the front edge of upper shelf 14 can be a curtain 30, which may be constructed of a variety of strips of flexible material, such as cloth, ribbons, rubber, leather, and beads. The curtain 30 prevents the user from seeing the pads 28 while enabling the user to pass his/her hand though the strips of material to feel the spaced sensory pads on the first planar sheet 26.

Additionally, a second planar sheet 32, preferably constructed of a semi-rigid material, such as plastic or sheet metal, is disposed upon first planar sheet planar 26. Second planar sheet 32 contains a plurality of element receiving openings 34 there through. As illustrated, there are sixteen element receiving openings 34 within second planar sheet 32. The element receiving openings 34 are arranged to overlay the spaced sensory pads 28 when the second planar sheet 32 is place on the first planar sheet 26. Although sixteen element receiving openings 34 are illustrated, it is within the terms of the present invention to use any number corresponding to the pads on the first planar sheet 26. Note that gel cushions 31a, 31b, 31c and 31d extend through second planar sheet 32 to form a pad between first planar sheet 26 and second planar sheet 32 to prevent sliding between these two elements. Holes 35a, 35b, 35c extend through second planar sheet 32 and overlay holes 29a,29b, 29c and 29d, respectively.

As illustrated, both the first and second semi-rigid planar sheets 26 and 32, respectively, are substantially rectangular in shape. However, it is within the terms of the present invention to make them any desired shape as long as the element receiving openings 34 of the second planar sheet 32 overlies the spaced sensory pads 28 on the first planar sheet 26.

A plurality of elements 36 are provided, each with a sensory pad of material having a different texture, such as but not limited to sandpaper, fur, cloth, glass, and plastic corresponding to the spaced sensory pads 28 on one surface. As illustrated, elements 36 are construed as cylindrical capsules. The elements 36 can be made of any material such as plastic. The elements 36 are sized to fit into the element receiving openings 34. While elements 36 are illustrated as being cylindrical capsules, it is within the terms of the invention to form them of other shapes which correspond to the openings 34 of different shapes.

FIG. 3 illustrates first planar sheet 26 and second planar sheet 32 in detail. Element receiving openings 34 through the second planar sheet 32 are designed to lie directly over spaced sensory pads 28. As mentioned before, each spaced sensory pad 28 has a different texture, such as sandpaper, fur, cloth, glass, and plastic and each of the elements 36 has a different material corresponding to the spaced sensory pads 28. The elements 36 are designed to rest in the element receiving openings 34, atop the spaced sensory pads 28 having the same material as that affixed to the elements 36.

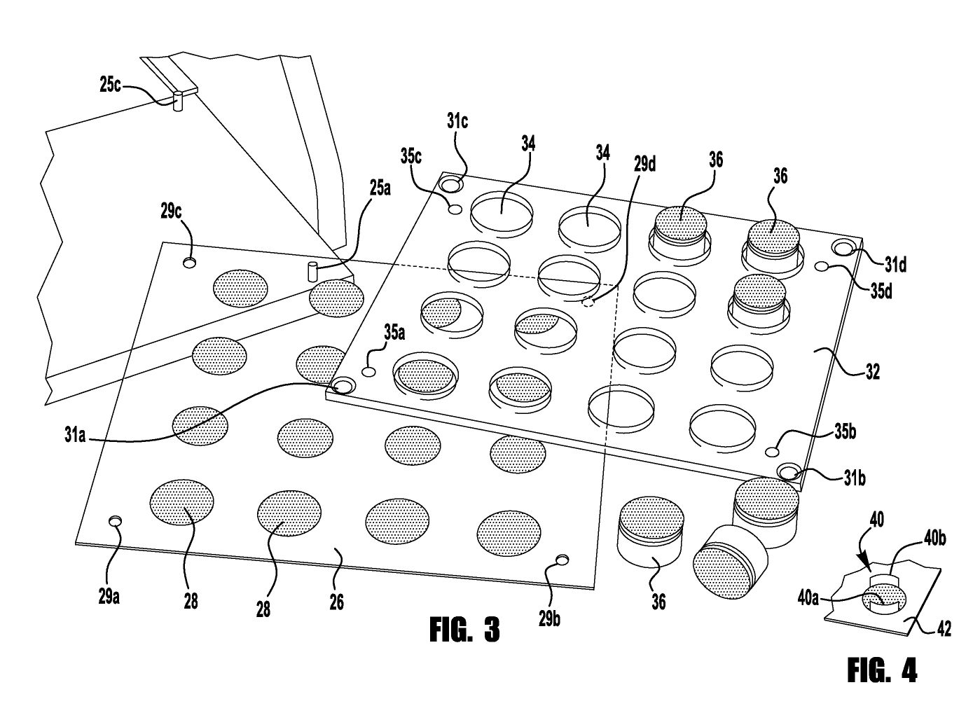

In another embodiment of the present invention, as shown in FIG. 4, the first planar sheet 42 (compare 26) can have stabilizing structure 40, such as for example, two opposed upstanding walls 40a, 40b around the sensory pads, so that the elements 36 can be removably secured on the first planar sheet 26 without the need for the second planar sheet 32.

In practice, therapeutic sensory device 10 operates as follows. A therapist places the elements 36 within containers 16a and 16b that are typically filled with a particular matter such as, for example, plastic discs, beads or sand, or organic matter such as beans and/or rice. The lower shelf 24 is pulled out as shown in FIG. 2 and the first planar sheet 26 and the second planar sheet 32 are disposed on the bottom shelf. Then the lower shelf 24 is moved into the housing 12 to the position displayed in FIG. 1, such that it is contained within the interior of housing 12. The slide bar 33 can then be moved into place to secure the lower shelf 24 in place.

The patient first touches a spaced sensory pad 28 and the places his/her hands in the containers 16a and 16b. Then, he/she, using the sense of touch, removes a element 36 from the medium contained within containers 16a and 16b having the same material as the touch pad they first touched. The patient then reaches his/her hand past curtain 30, and places the element 36 in the element receiving opening 34 covering the spaced sensory pad 28 of the same material as that on the top of the element 36 that was drawn.

Although the invention has been shown and described with respect to a certain preferred embodiment or embodiments, certain equivalent alterations and modifications will occur to others skilled in the art upon the reading and understanding of this specification and the annexed drawings. In particular regard to the various methods and apparatus used in rehabilitation of an individual's sense of touch (i.e., that is functionally equivalent), even though not equivalent to the disclosed methods or apparatus which performs the function in the herein illustrated exemplary embodiments of the invention. In addition, while a particular feature of the invention may have been disclosed with respect to only one of several embodiments, such a feature may be combined with one or more features of the other embodiments as may be desired and advantageous for any given or particular application.

1. A therapeutic sensory device for aid in the rehabilitation of an individual's sense of touch, comprising:
a first planar sheet having a plurality of spaced sensory pads, disposed thereon;
a plurality of elements, each having a sensory pad corresponding to one of the spaced sensory pads, each of said plurality of elements being adapted to be placed on the corresponding sensory pad disposed on the first planar sheet; and
a structure to removably secure the plurality of elements atop the corresponding sensory pad disposed on the first planar sheet.

2. The therapeutic sensory device of claim 1 wherein the structure to secure the plurality of elements to the first planar sheet is a second planar sheet having a plurality of element receiving openings there through, said openings adapted to overlay the sensory pads disposed on the first planar sheet to keep the plurality of elements removably secured thereon.

3. The therapeutic sensory device of claim 1 further including a housing having two parallel upper and lower shelves secured between two parallel side walls.

4. The therapeutic sensory device of claim 3 wherein the housing is constructed of a material selected from the group consisting of wood, metal, a plastic polymer and glass.

5. The therapeutic sensory device of claim 3 wherein the upper shelf supports at least one container having one or more of the plurality of elements therein.

6. The therapeutic sensory device of claim 3 wherein a curtain of strips of material is suspended across the front edge of the upper shelf.

7. The therapeutic sensory device of claim 5 wherein each container contains a medium selected from the group consisting essentially of sand, straw, saw dust, rubber flakes and powder.

8. The therapeutic sensory device of claim 3 wherein the parallel side walls each contain elongated ridges extending along the lower portion of the interior walls.

9. The therapeutic sensory device of claim 8 wherein the lower shelf is constructed with grooves along its side walls to receive the elongated ridges and allow the bottom shelf to slide in and out of the box.

10. The therapeutic sensory device of claim 3 wherein the first planar sheet having a plurality of spaced sensory pads disposed thereon is removably secured to the lower shelf.

11. The therapeutic sensory device of claim 1 wherein the plurality of elements are cylindrical capsules, each having a sensory pad secured thereto corresponding to one of the spaced sensory pads of the first planar sheet.

12. The therapeutic sensory device of claim 1 wherein the structure to removably secure the plurality of elements atop the corresponding sensory pad disposed on the first planar sheet is a plurality of upstanding ridges disposed about the sensory pads on the first planar sheet.

13. The therapeutic sensory device of claim 3 wherein:
the lower shelf has at least two upstanding pins; and
the first planar sheet has at least two though holes to receive the at least two upstanding pins in order to position the first planar sheet on the lower shelf.

14. The therapeutic sensory device of claim 3 wherein:
the first planar sheet has at least two upstanding sheet pins; and
the second planar sheet has at least two though holes to receive the at least two upstanding sheet pins in order to position the second planar sheet on the first planar sheet.

15. A method for rehabilitating an individual's sense of touch, comprising:
providing a first planar sheet having a plurality of spaced sensory pads disposed thereon;
providing a plurality of elements, each having a sensory pad corresponding to one of the spaced sensory pad;
selectively placing said plurality of elements atop the corresponding sensory pad disposed on the first planar sheet; and
removably securing one or more of the plurality of elements atop the corresponding sensory pad disposed on the first planar sheet.

16. The method for rehabilitating an individual's sense of touch of claim 15 including:
touching one of the spaced sensory pads disposed on the first planar sheet;
selecting one of the plurality of elements having a sensory pad corresponding to the sensory pad touched on the first planar sheet; and
placing the selected one of the plurality of elements on the corresponding pad on the first planar sheet.

17. The method for rehabilitating an individual's sense of touch of claim 16 including placing the plurality of elements into a container filled with medium.

18. The method for rehabilitating an individual's sense of touch of claim 17 including:
reaching into the container with the plurality of elements having a sensory pad; and
removing the element having a sensory pad with the identical texture to that of the touched spaced sensory pad.

19. The method for rehabilitating an individual's sense of touch of claim 18 including:
placing the removed element through an element receiving opening of a second planar sheet and onto the corresponding spaced sensory pad of the first planar sheet.

20. The method for rehabilitating an individual's sense of touch of claim 18 including:
placing the removed element between a support structure about the corresponding spaced sensory pad of the first planar sheet.
